(19) United States
(12) Patent Application Publication
(10) Pub. No.: US 2026/0134464 A1
(43) Pub. Date: May 14, 2026

(54) ARTIFICIAL INTELLIGENCE AGENT TO RESPOND AUTOMATICALLY TO MONITORED USER ACTIONS

(71) Applicant: Maplebear Inc., San Francisco, CA (US)

(72) Inventors: Tilman Drerup, Palo Alto, CA (US); Sharath Rao Karikurve, Berkeley, CA (US); Haixun Wang, Bellevue, WA (US)

(21) Appl. No.: 18/940,847

(22) Filed: Nov. 8, 2024

(51) Int. Cl. G06Q 30/0601; G06Q 30/0207

(52) U.S. Cl. CPC G06Q 30/0617; G06Q 30/0222; G06Q 30/0635

(57) ABSTRACT

An artificial intelligence (AI) agent generates responses customized to a user based in part on monitored actions of the user. The AI agent, formed from a machine-learning model, is instantiated with inputs that include a set of objectives, an online catalog of items, and user data associated with a user of an online system. Actions performed by a user on the online system are monitored. Action types of at least some of the monitored actions are determined. Responsive to a determination that an action of the monitored actions has an action type of a set of predetermined types of actions, the AI agent is prompted with a description of the action and a request to suggest a response to the action. The determined response is based in part on one or more of the set of objectives. The response suggested by the AI agent is invoked.

### BACKGROUND

Conventional online systems interact with users, enabling them to conduct various activities online. Such activities may include video content posted by other users, researching for information on the Internet, or shopping online, among other activities. Occasionally, users have difficulty using an online site and need help to complete a task. Additionally, it may be desirable for an online site to spot opportunities for intervention in a user’s behavior and then act on them, such as if the site detects fraudulent activity by a user. Some online systems employ hard-coded rules engines and machine learning models to handle specific situations (e.g., one model during checkout, another model while browsing, etc.). However, this can be inefficient, especially for cases where there are a large number of situations in which a user may need help. It also fails to address user problems that have not been specifically anticipated by the online system. Other online systems employ webchat interfaces where humans assist users to access features of the online system, but this also does not scale well and can be expensive to maintain.

### SUMMARY

In accordance with one or more aspects of the disclosure, an artificial intelligence (AI) agent is configured to generate responses customized to a user based in part on monitored actions of the user. Such actions may include viewing content on a site, adding or removing items to or from an order, searching for items in a database, etc. The AI agent may be formed from a machine-learning model, such as a large language model (LLM). The AI agent may be trained to output a response for the online system to make based on an action made by a user interacting (via a user client device) with the online system. The AI agent determines a response based in part on one or more objectives (e.g., threshold level of profit for a transaction, ensuring a threshold level of ad impressions for items from the online catalog, etc.) of the online system.

The AI agent may be instantiated with inputs that include a set of objectives, an online catalog of items, and user data associated with a user of an online system. Some or all actions performed by the user (via a user client device) on the online system are monitored. The user may opt-in to allow the online system to monitor their actions on the online system. Action types of at least some of the monitored actions are determined. The online system or the AI agent determines whether an action of the monitored actions has an action type of a set of predetermined types of actions. In embodiments where there is no match, the online system or the AI agent may compare one or more other actions of the monitored actions to the set of predetermined types of actions. Once a match occurs such that an action of the monitored actions has an action type that matches a set of predetermined types of actions, the online system prompts the AI agent with a description of the action and a request to suggest a response to the action. The response is based in part on one or more of the set of objectives. The response (e.g., provide discount on item) suggested by the AI agent may then be invoked. In some embodiments, invoking a response may include requesting services from one or more other machine-learning models, and performing actions based in part on outputs from the one or more other machine-learning models.

The online system may monitor actions of the user caused by invoking the response. The online system may evaluate, using one or more performance metrics (e.g., amount of profit made on a transaction, whether user completed transaction, etc.), how well the response achieved one or more of the set of objectives. The online system may tune the AI agent using, e.g., the response, that action data (e.g., the action resulting in the response, actions of the user caused by the response), and the one or more performance metrics. In this manner, the online system can refine and improve further responses by the AI agent.

In one or more embodiments, an AI agent comprises a single model that generates responses to a wide range of actions by the user. In one or more other embodiments, an AI agent comprises multiple models that are used to handle different aspects of a user’s interaction with the online system. Additionally, when the AI agent has been instantiated and tuned using data specific to the user (or to a cohort of users), the responses are tailored to that user. In this manner, the AI agent may map actions of a user to an intent of the user for an order session, and determine responses that not only meet the intent of the user but also meet some or all of the set of objectives of the online system.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIG. 3 is a diagram describing the operation of an AI agent, in accordance with one or more embodiments.

FIG. 4 is a flowchart for a method of using an AI agent to generate responses customized to a user based in part on monitored actions of the user, in accordance with some embodiments.

### DETAILED DESCRIPTION

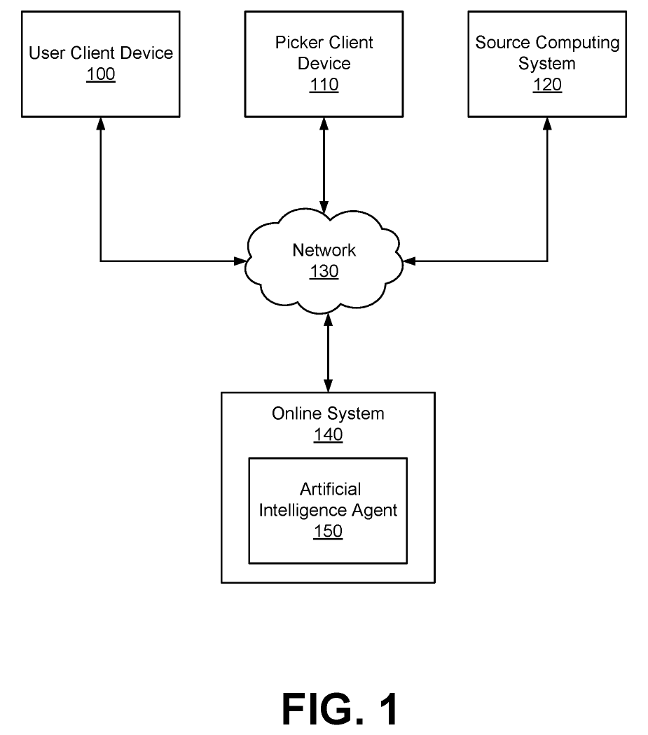

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

A user uses the user client device 100 to place an order with the online system 140 as part of an order session. An order session describes a time period over which a user starts and completes an order. The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

In some embodiments, the user client device 100 presents (e.g., via the ordering interface) monitoring preferences. The monitoring preferences (e.g., which specific interactions with the online system 140 may be monitored) relate to monitoring of some or all actions of the user (via the user client device 100) on the online system 140. The user may opt in, or opt out, of monitoring actions of the user on the online system 140 by adjusting their monitoring preferences. The user client device 100 may provide the monitoring preferences of the user to the online system 140.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user’s order may specify which groceries they want to be delivered from the grocery store and the quantities of each of the groceries. The user’s client device 100 transmits the user’s order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 uses an artificial intelligence (AI) agent 150 to generate responses customized to a user based in part on monitored actions of the user. In the illustrated embodiments, the AI agent is part of the online system 140. In other embodiments, some or all of the AI agents may be on the user client device 100. The AI agent 150 comprises a machine-learning model and is trained to respond to some types of monitored actions of users on the user client devices in accordance with a set of objectives. The AI agent 150 may be configured to make decisions using, e.g., a Monte Carlo Tree Search (MCTS) algorithm.

In one or more embodiments, the AI agent 150 comprises a large language model (LLM). The online system 140 may train or tune the AI agent 150 with information about the online system (e.g., a catalog or database of items served by the online system 140) and a set of objectives important to an operator of the online system 140. In the case where the AI agent 150 comprises an LLM, the online system 140 may tune the parameters of the LLM with the business information and the objectives. To personalize the AI agent 150 for a user or a cohort of users, the online system 140 may further tune the AI agent 150 with information about the user or users, such as preferences, information about previous engagement with the online system 140, or any other information about the users tracked by the online system 140. The online system 140 may use prompt tuning, which tunes an LLM instance of the AI agent 150, or the online system 140 may train the parameters to create multiple AI agents 150.

To start using the AI agent 150, the online system 140 may instantiate the AI agent 150 with inputs (e.g., a set of objectives, user data, item data, online catalog, etc.). In some embodiments, in response to an order session being started between the user device 100 and the online system 140, the online system 140 instantiates the AI agent 150. Moreover, while the user interacts with the online system 140 during a particular session, the online system 140 may further tune the AI agent 150 with contextual information about the session so that the AI agent 150 can provide better responses based on the user’s current experience.

The online system 140 monitors some or all actions performed by the user, via the user client device 100, on the online system 140. In some embodiments, the online system 140 determines action types of at least some of the monitored actions. Responsive to determining that an action of the monitored actions has an action type of a set of predetermined types of actions, the online system 140 may prompt the AI agent with a description of the action and a request to suggest a response to the action. The response output from the AI agent 150 is based in part on one or more of the set of objectives. The AI agent 150 may then invoke the determined response.

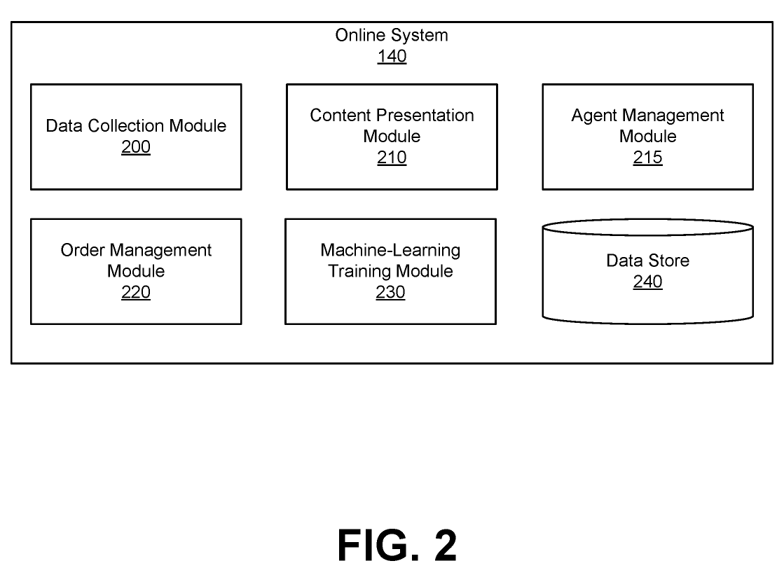

As an example, during an ordering session with the online system 140, a user may start a process to remove an item from an ordering list. The online system 140 may monitor actions of the user on the online system 140 and, at some point, determine that the action of starting the process to remove the item from the ordering list matches a set of predetermined types of actions. Responsive to this determination, the online system 140 may prompt the AI agent 150 with a description of the action (e.g., user has requested removal of an item from the order list) and a request to suggest a response to the action. The AI agent 150 may generate a response based on the prompt and one or more of the set of objectives. For example, the AI agent 150 may determine a response to, prior to removal of the item from the order list, offer a discount on the item. The AI agent 150 may then invoke the determined response (e.g., provide the discount to the ordering interface for presentation to the user). The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an agent management module 215, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users. In one or more embodiments, the features described herein that involve data collection, including the AI/ML features, are invoked and performed only after a user has explicitly consented to the invocation and performance of such features by the corresponding algorithms or services.

For example, the data collection module 200 collects user data, which is information or data that describe characteristics of a user. User data may include a user’s name, address, shopping preferences, favorite items, stored payment instruments, prior order histories (e.g., what items were ordered, from which sources, prices paid, etc.). The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. Item data may also include pricing information. The pricing information may include a price for an item, discounts associated with items, etc. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be substitutes for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The agent management module 215 uses one or more AI agents (e.g., the AI agent 150) to generate responses that are customized to users based in part on monitored actions of those users. In some embodiments, a single AI agent may be used for a plurality of different users. In other embodiments, each user is associated with a different AI agent that is tuned for that specific user. In yet other embodiments, the users are segmented into cohorts of users having similar characteristics, and each cohort of users is associated with a different AI agent that is tuned for that cohort. In some embodiments, some or all of the one or more AI agents are part of the online system 140. In other embodiments, some or all of the one or more AI agents may be on user client devices. An AI agent is a machine-learning model and is trained to respond to some types of monitored actions of users on the user client devices in accordance with a set of objectives of the online system 140. The AI agent may be configured to make decisions using, e.g., a Monte Carlo Tree Search (MCTS) algorithm.

The set of objectives are goals used by the agent management module 215 to guide behavior and decision making of the AI agent 150. An objective may be, e.g., having at least a threshold level of profit for a transaction, ensuring a threshold level of ad impressions for items from the online catalog, ensuring a threshold level of ad impressions for sponsored items from the online catalog, maintaining a level of user satisfaction (e.g., selecting items that are requested by the user), assisting sources in turning over inventory, fulfillment costs being less than a threshold value, etc. Each of the objectives may be associated with a weight value, and in some embodiments, different objectives may have different weight values. For example, having at least a threshold level of profit for a transaction may have a higher weighting than, e.g., assisting sources in turning over inventory.

The agent management module 215 may instantiate an AI agent with inputs (e.g., the set of objectives, user data associated with a user, item data, online catalog, etc.). In some embodiments, the agent management module 215 instantiates the AI agent in response to a user participating in or beginning an order session via a user client device associated with the user.

The agent management module 215 or the AI agent 150 monitors some or all actions (e.g., searches for items, adding or removing an item from the order list, etc.) performed by a user on the online system 140. For example, a user may perform an action on an ordering list (e.g., add item, remove item, etc.), and the agent management module 215 may log the performed action. In some embodiments, different logs are used to record actions of different types. The monitored actions may be referred to as action data. For example, the agent management module 215 may log actions of users of the online system 140 in one or more logs to form the action data. In some embodiments, the agent management module 215 uses the AI agent to monitor user actions.

In some embodiments, the agent management module 215 or the AI agent may collect data from one or more other modules (e.g., data collection module 200, the order management module 220, etc.) to generate some of the action data. The user may opt-in to allow the agent management module 215 or the agent management module 215 to monitor their interactions (via their user client device) with the online system 140. In some embodiments, the agent management module 215 or the agent management module 215 may receive monitoring preferences from the user client device 100 associated with the user. The monitoring preferences may include, e.g., whether to opt in or opt out of having their interactions with the online system 140 monitored, which specific interactions with the online system 140 may be monitored, or how the action data is monitored.

The agent management module 215 or the AI agent 150 determines action types (e.g., removal of item from order list) of at least some of the monitored actions. The agent management module 215 or the AI agent 150 may determine a type of action using the action data. Responsive to determining that an action of the monitored actions has an action type of a set of predetermined types of actions, the agent management module 215 or the AI agent 150 may prompt the AI agent 150 with a description of the action and a request to suggest a response to the action. The response output from the AI agent 150 is based in part on one or more of the set of objectives. In some instances, the response to an action may be to do nothing. In contrast, for other actions, for the user and the action performed, the response may be to, for example, help a user with an error message, provide a discount for a product, present an advertisement for an item that is targeted to the user, etc.

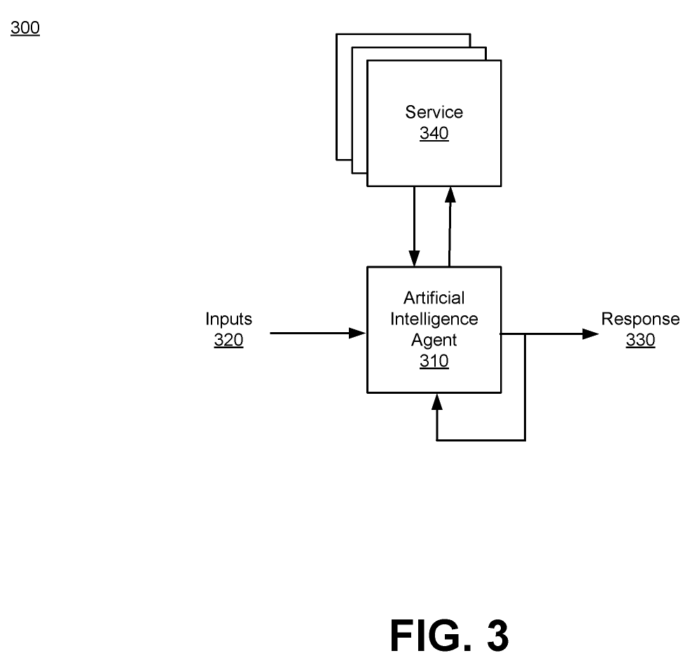

The AI agent 150 may then invoke the determined response. In some embodiments, invoking a response may be performing an action described in the response. In some embodiments, invoking a response may include requesting services from one or more other machine-learning models, and performing actions based in part on outputs from the one or more other machine-learning models that are used for specific tasks. For example, in addition to the AI agent 150, the online system 140 may include, e.g., a targeting machine-learning model, a discount machine-learning model, etc. The targeting machine-learning model may, e.g., be used to choose target advertisements for presentation to a user. The discount machine-learning model may, e.g., determine an amount of a discount to provide to a user to incentivize a user to purchase the item while also ensuring a profit margin above a threshold level. As such, in some embodiments, invoking a response includes requesting a service that uses an additional machine-learning model to generate an output, and performing an action based in part on the output. An example AI Agent is further described below with regard to FIG. 3.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. For example, the machine-learning training module 230 may be used to train one or more AI agents (e.g., the AI agent 150), and in some embodiments, other task specific machine-learning models (e.g., discount machine-learning model, targeting machine-learning model, etc.). The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data (e.g., prior order histories, user preferences, etc.), picker data, item data, order data, or action data, which may be referred to respectively as, training user data, training picker data, training item data, training order data, and training action data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

For example, in some embodiments, the machine-learning training module 230 trains an AI agent by accessing a set of training examples including training action data, training user data, training item data, training order data, and a training set of objectives. The machine-learning training module 230 then applies the AI agent to the set of training examples to generate a training output corresponding to a predicted set of proposed responses. The machine-learning training module 230 back-propagates one or more error terms obtained from one or more loss functions to update a set of parameters of the machine-learning model, and one or more of the error terms are based on a difference between a label applied to a test interaction of the set of training examples and the predicted set of proposed responses. The machine-learning training module 230 may stop the back-propagation after the one or more loss functions satisfy one or more criteria.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 retrains the machine-learning model using the additional training data, using any of the methods described above. This deployment and retraining process may be repeated over the lifetime use for the machine-learning model. This way, the machine-learning model continues to improve its output and adapts to changes in the system environment, thereby improving the functionality of the online system 140 as a whole in its performance of the tasks described herein. In this manner, one or more AI agents may be retrained. For example, the machine-learning training module 230 may determine additional training examples using order data and action data, and retraining the AI agent based in part on the additional training examples.

The data store 240 stores data used by the online system 140. For example, the data store 240 stores user data, item data, order data, action data, and picker data for use by the online system 140. In some embodiments, the data store 240 may also store constraints associated with users. The data store 240 also stores trained machine-learning models (e.g., one or more AI agents, discount machine-learning model, targeting machine-learning model, etc.) trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 is a diagram 300 describing the operation of an AI agent 310, in accordance with one or more embodiments. The AI agent 310 is an embodiment of the AI agent 150. Some embodiments of the AI agent 310 have different components or functions than those described here. Similarly, in some cases, functions can be distributed among the components in a different manner than is described here.

Some or all actions (e.g., searches for items, adding or removing an item from the order list, etc.) performed by a user using a user client device (e.g., the user client device 100) to interact with the online system 140 are monitored (e.g., via the AI agent 310 or the agent management module 215). As described above, at least some (e.g., matches an action type of a set of predetermined types of actions), and in some cases all of the monitored actions are provided to the AI agent 310.

Inputs 320 are generated (e.g., by the agent management module 215 or the AI agent 310) based in part on a monitored action (“action”). The inputs 320 include a prompt that includes, e.g., a description of the action and a request to suggest a response to the action. The inputs 320 are applied to the AI agent. In one or more embodiments, the inputs 320 include the output from other concurrently running models, such as the estimated probability of a session being fraudulent. The inputs 320 may also include other types of data, such as item data, user data, picker data, order data, etc.

The AI agent 310 determines a response 330 based in part on one or more of the set of objectives (e.g., having at least a threshold level of profit for a transaction, ensuring a threshold level of ad impressions for items from the online catalog, ensuring a threshold level of ad impressions for sponsored items from the online catalog, etc.). In some embodiments, the AI agent 310 may determine a response from a set of predetermined responses in accordance with one or more objectives of the set of objectives. In some embodiments, to generate a response the AI agent 310 may request an output from a service 340 that uses a machine-learning model that is trained for a specific task. The AI agent 310 may use the output from the service 340 to generate the response 330.

For example, a monitored action may be that a user has requested to remove an item from an order cart and the item is above a threshold price, and an objective of the AI agent 310 may be to encourage sales of items over the threshold price. The AI agent 310 may determine based in part on the action and the objective that a response is to provide a discount on the item to incentivize a sale of it. While in some embodiments, the AI agent 310 may have been trained to also determine the amount of the discount. In other embodiments, the AI agent 310 may generate a prompt for a discount machine-learning model (e.g., the service 340) that it requests to determine an amount of the discount to provide on the item. The amount of the discount may be based on, e.g., an order history of the user (e.g., may add more of a discount to a new user to encourage repeat sales), item information from a source selling the item (e.g., the source may have authorized additional discounts of the item), etc. Responsive to the prompt, the discount machine-learning model provides an output including a suggested discount to the AI agent 310. The AI agent 310 generates the response 330 using the output. The response 330 may instruct the user client device to present the discount to the user. In some embodiments, the discount may be presented (e.g., via a pop on menu on the ordering interface) with an option to keep the item in the order list at the discounted price, or to finalize the removal of the item from the order list.

In another example, the monitored action may be a search query made of the online catalog, and an objective of the AI agent 310 may be to have a threshold level of ad impressions for items from the online catalog. The AI agent 310 may determine based in part on the action and the objective that the user is not simply shopping for specific items, but is more generally browsing the online catalog. And as the user appears to be browsing, the AI agent 310 may infer that the user is open to more targeted advertising than the user would be if the user were looking for a specific item. As such, the AI agent 310 may determine a response that includes presenting a plurality of advertisements of items of the online catalog that are less tightly constrained to the search query than if the user were shopping for a specific item.

The AI agent 310 or the agent management module 215 may monitor actions of the user in response to the response 330. The AI agent 310 or the agent management module 215 may evaluate, using one or more performance metrics (e.g., amount of profit made on a transaction, whether user completed transaction, etc.), how well the response 330 achieved one or more of the set of objectives. The AI agent 310 may be tuned or retrained using, e.g., the response 330, action data (e.g., the action resulting in the response 330, actions of the user in response to the response 330), and the one or more performance metrics. In this manner, the AI agent 310 may be able to refine and improve further responses output by the AI agent 310.

In one or more embodiments, the AI agent 310 generates a response 330 to a wide range of actions by the user. Moreover, tuning or retraining of the AI agent 310 based on generated responses over time are such that the AI agent 310 may map actions of the user to an intent of the user for an order session, and determine responses that not only meet the intent of the user but also meet some or all of the set of objectives of the online system 140.

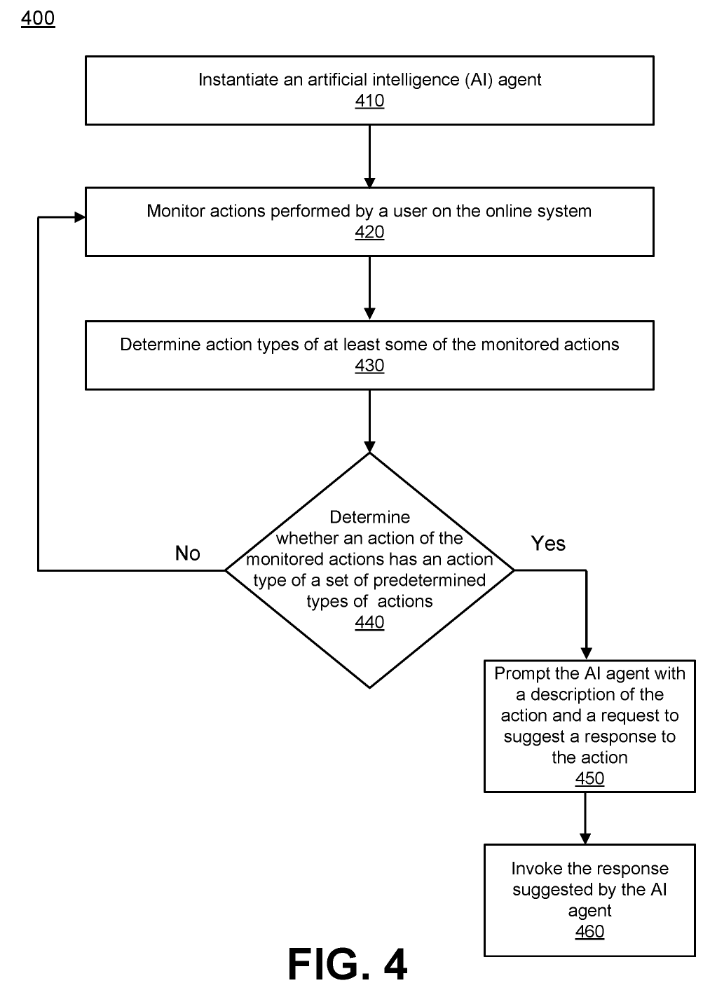

FIG. 4 is a flowchart 400 for a method of using an AI agent to generate responses customized to a user based in part on monitored actions of the user, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system instantiates 410 an AI agent. The AI agent is formed from a machine-learning model. The online system 140 instantiates the AI agent with inputs that include, for example: a set of objectives, an online catalog of items, and user data associated with a user of an online system. In some embodiments, the inputs may also include other data (e.g., order data, item data, etc.).

The online system monitors 420 actions performed by a user on the online system. The online system may log the performed actions using one or more logs to form action data. The online system monitors the actions in accordance with monitoring preferences of the user.

The online system determines 430 action types of at least some of the monitored actions. The online system may determine a type of action using the action data. For example, action types relating to search terms received from a log storing received searches, and action types relating to the order list may be stored in a log tracking changes to an order list.

The online system determines 440 whether an action of the monitored actions has an action type of a set of predetermined types of actions. In embodiments where there is no match, the process moves to step 420.

In contrast, responsive to determining that an action of the monitored actions has an action type of a set of predetermined types of actions, the online system prompts 450 (e.g., via a prompt) the AI agent with a description of the action and a request to suggest a response to the action. In some embodiments, the AI agent may generate the prompt. The response of the AI agent is based in part on the action and the one or more objectives of the set of objectives of the online system.

The online system invokes 460 the response suggested by the AI agent. In some embodiments, invoking a response may include requesting services from one or more other machine-learning models, and performing actions based in part on outputs from the one or more other machine-learning models. For example, the services requested may include predicting a likelihood of a user interaction with an item, a prediction about whether a session is fraudulent, or any other prediction from a machine-learning model. In some instances, the response may be to not respond to the action.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium of an online system, comprising:
instantiating an artificial intelligence (AI) agent, the AI agent comprising a large language model (LLM), where the AI agent is tuned using a set of objectives, an online catalog of items, and user data associated with a user of an online system;
monitoring actions performed by a user on the online system;
identifying action types of at least some of the monitored actions;
identifying that an action of the monitored actions has an action type of a set of predetermined types of actions;
responsive to identifying that the action of the monitored actions has the action type of the set of predetermined types of actions, prompting the AI agent with a description of the action and a request to suggest a response to the action, wherein the identified response is based in part on one or more of the set of objectives; and
invoking the response suggested by the AI agent, wherein invoking the response comprises initiating a computing process.

2. The method of claim 1, wherein the AI agent was trained by:
accessing a set of training examples including training action data, training user data, training item data, training order data, and a training set of objectives;
applying the AI agent to the set of training examples to generate a training output corresponding to a predicted set of proposed responses;
back-propagating one or more error terms obtained from one or more loss functions to update a set of parameters of the LLM, and one or more of the error terms are based on a difference between a label applied to a test interaction of the set of training examples and the predicted set of proposed responses; and
stopping the back-propagation after the one or more loss functions satisfy one or more criteria.

3. The method of claim 1, further comprising:
generating additional training examples using order data and action data; and
retraining the AI agent based in part on the additional training examples.

4. The method of claim 1, wherein invoking the response suggested by the AI agent further comprises:
requesting, by the AI agent, a service that uses an additional machine-learning model to generate an output; and
performing an action based in part on the output.

5. The method of claim 4, wherein the monitored action is the user starting a process to remove an item above a threshold price from an order cart, the response is to provide a discount on the item, the output is an amount of the discount, and performing the action based in part on the output further comprises:
providing a message for presentation to the user, the message offering the discount on the item.

6. The method of claim 4, further comprising:
selecting the service from a plurality of services based in part on the response, wherein each of the plurality of services uses a different machine-learning model.

7. The method of claim 1, wherein the AI agent is executed by a user client device.

8. The method of claim 1, wherein instantiating the AI agent comprises:
coordinating with a user client device to begin an order session; and
responsive to beginning the ordering session, tuning the AI agent.

9. A computer program product comprising a non-transitory computer readable storage medium having instructions encoded thereon that, when executed by a processor of a computer system, cause the computer system to perform actions comprising:
instantiating an artificial intelligence (AI) agent, the AI agent comprising a large language model (LLM), where the AI agent is tuned using a set of objectives, an online catalog of items, and user data associated with a user of an online system;
monitoring actions performed by a user on the online system;
identifying action types of at least some of the monitored actions;
identifying that an action of the monitored actions has an action type of a set of predetermined types of actions;
responsive to identifying that the action of the monitored actions has the action type of the set of predetermined types of actions, prompting the AI agent with a description of the action and a request to suggest a response to the action, wherein the identified response is based in part on one or more of the set of objectives; and
invoking the response suggested by the AI agent, wherein invoking the response comprises initiating a computing process.

10. The computer program product of claim 9, wherein the AI agent was trained by:
accessing a set of training examples including training action data, training user data, training item data, training order data, and a training set of objectives;
applying the AI agent to the set of training examples to generate a training output corresponding to a predicted set of proposed responses;
back-propagating one or more error terms obtained from one or more loss functions to update a set of parameters of the LLM, and one or more of the error terms are based on a difference between a label applied to a test interaction of the set of training examples and the predicted set of proposed responses; and
stopping the back-propagation after the one or more loss functions satisfy one or more criteria.

11. The computer program product of claim 9, further comprising encoded instructions that when executed cause the computer system to perform actions comprising:
generating additional training examples using order data and action data; and
retraining the AI agent based in part on the additional training examples.

12. The computer program product of claim 9, wherein the encoded instructions to invoke the response suggested by the AI agent further comprises instructions that when executed cause the computer system to perform actions comprising:
requesting, by the AI agent, a service that uses an additional machine-learning model to generate an output; and
performing an action based in part on the output.

13. The computer program product of claim 12, wherein the monitored action is the user starting a process to remove an item above a threshold price from an order cart, the response is to provide a discount on the item, the output is an amount of the discount, and wherein the encoded instructions to perform the action based in part on the output instructions that when executed cause the computer system to perform actions comprising:
providing a message for presentation to the user, the message offering the discount on the item.

14. The computer program product of claim 12, further comprising encoded instructions that when executed cause the computer system to perform actions comprising:
selecting the service from a plurality of services based in part on the response, wherein each of the plurality of services uses a different machine-learning model.

15. The computer program product of claim 9, wherein the AI agent is configured to be executed by a user client device.

16. The computer program product of claim 9, wherein the encoded instructions to instantiating the AI agent comprises instructions that when executed cause the computer system to perform actions comprising:
coordinating with a user client device to begin an order session; and
responsive to beginning the ordering session, tuning the AI agent.

17. A computer system comprising:
a processor; and
a non-transitory computer readable storage medium having instructions encoded thereon that, when executed by the processor, cause the computer system to perform actions comprising:
instantiating an artificial intelligence (AI) agent, the AI agent comprising a large language model (LLM), where the AI agent is tuned using a set of objectives, an online catalog of items, and user data associated with a user of an online system;
monitoring actions performed by a user on the online system;
identifying action types of at least some of the monitored actions;
identifying that an action of the monitored actions has an action type of a set of predetermined types of actions;
responsive to identifying that the action of the monitored actions has the action type of the set of predetermined types of actions, prompting the AI agent with a description of the action and a request to suggest a response to the action, wherein the identified response is based in part on one or more of the set of objectives; and
invoking the response suggested by the AI agent, wherein invoking the response comprises initiating a computing process.

18. The system of claim 17, wherein the AI agent was trained by:
accessing a set of training examples including training action data, training user data, training item data, training order data, and a training set of objectives;
applying the AI agent to the set of training examples to generate a training output corresponding to a predicted set of proposed responses;
back-propagating one or more error terms obtained from one or more loss functions to update a set of parameters of the LLM, and one or more of the error terms are based on a difference between a label applied to a test interaction of the set of training examples and the predicted set of proposed responses; and
stopping the back-propagation after the one or more loss functions satisfy one or more criteria.

19. The system of claim 17, wherein the encoded instructions to invoke the response suggested by the AI agent further comprises instructions that when executed cause the computer system to perform actions comprising:
requesting, by the AI agent, a service that uses an additional machine-learning model to generate an output; and
performing an action based in part on the output.

20. The system of claim 19, wherein the monitored action is the user has begun a process to remove an item above a threshold price from an order cart, the response is to provide a discount on the item, the output is an amount of the discount, and wherein the encoded instructions to perform the action based in part on the output instructions that when executed cause the computer system to perform actions comprising:
providing a message for presentation to the user, the message offering the discount on the item.
